(19) United States
(12) Patent Application Publication
(10) Pub. No.: US 2005/0008301 A1
(43) Pub. Date: Jan. 13, 2005

(54) Optical-fiber connector and display apparatus

(75) Inventors: Kazuyoshi Fuse, Fukaya-shi (JP); Shigeru Kato, Tokyo (JP); Takashi Togasaki, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/875,516

(22) Filed: Jun. 25, 2004

(30) Foreign Application Priority Data
Jun. 27, 2003 (JP) 2003-185276

(51) Int. Cl. G02B 6/36

(52) U.S. Cl. 385/78

(57) ABSTRACT

An optical-fiber connector comprises a first optical fiber, a first ferrule which has a cutout portion in at least a periphery of one end face thereof and holds the first optical fiber such that a front end of the first optical fiber becomes the same face as the one end face, a second optical fiber, a second ferrule which has a cutout portion in at least a periphery of one end face thereof and holds the second optical fiber such that a front end of the second optical fiber becomes the same face as the one end face, and an adhesive which connects the one end face of the first ferrule with the one end face of the second ferrule.

### CROSS-REFERENCE TO RELATED APPLICATIONS

This application is based upon and claims the benefit of priority from prior Japanese Patent Application No. 2003-185276, filed Jun. 27, 2003, the entire contents of which are incorporated herein by reference.

### BACKGROUND OF THE INVENTION

1. Field of the Invention

The present invention relates to an optical-fiber connector and a display apparatus using the connector.

2. Description of the Related Art

Conventional examples of optical-fiber connectors will be described hereinunder. Generally, when optical fibers formed of the same material, such as quartz glass, are connected, a fusion splice technique is employed. However, such the fusion splice technique cannot be used to connect two optical fibers formed of different materials (such as quartz glass and fluoride) since the melting points of the materials are different from each other.

A conventional example of a technique for a connector of optical fibers formed of different materials, a technique has been developed in which end faces of the optical fibers are brought into abutment with each other, and the joint portion in that state is fixed in a predetermined manner (refer to Japanese Patent Application KOKAI Publication No. 11-218634). In this publication, there is disclosed a connector of the optical fibers, in which two optical fibers held by ferrules in a state where the optical fibers jut out by a predetermined amount from abutting end faces of ferrules cut out perpendicular to respective optical axes are oppositely fixed together via a connecting adhesive. According to the technique, when jut-out amounts of the optical fibers are reduced, the amount of the connecting adhesive can be reduced, and the connection strength can be enhanced.

However, the optical fibers to be connected are more or less jut out from the ferrules holding the optical fibers, so that when the optical fibers are strongly press-connected at the time of axial alignment processing, there can occur damage on the ends of the optical fibers. In addition, the optical fibers are brought into abutment with each other only at a low force, so that even when the axial alignment has been accurately achieved, the state cannot be maintained strong. Therefore, the adhesive is expanded by high heat in use, and the axial misalignment can occur, thereby introducing laser output variations.

Thus, in the connector of two optical fibers formed of different materials, that is, the connector in which the optical fibers in the states where the fibers are jut out of the abutting end faces of the ferrules, are connected such that abutting end faces of the ferrules are oppositely connected, the fibers may be damaged at the time of press connection for axial alignment processing, so that accurate axial alignment cannot-be achieved.

### BRIEF SUMMARY OF THE INVENTION

An object of the present invention is to provide an optical-fiber connector for connecting two optical fibers held in ferrules such that the optical fibers are less damaged and a state where axial alignment is performed can be maintained.

Another object of the present invention is to provide a display apparatus using the connector.

According to an embodiment of the present invention, an optical-fiber connector comprises:

a first optical fiber;

a first ferrule which has a cutout portion in at least a periphery of one end face thereof and holds the first optical fiber such that a front end of the first optical fiber becomes the same face as the one end face;

a second optical fiber;

a second ferrule which has a cutout portion in at least a periphery of one end face thereof and holds the second optical fiber such that a front end of the second optical fiber becomes the same face as the one end face; and

an adhesive which connects the one end face of the first ferrule with the one end face of the second ferrule.

According to another embodiment of the present invention, an optical-fiber connector comprises:

a first optical fiber;

a first ferrule which has a cutout portion in at least a periphery of one end face thereof and holds the first optical fiber such that a front end of the first optical fiber becomes the same face as the one end face;

a first ferrule holder which houses a portion other than the one end face of the first ferrule and has a first flange on an outer circumference of the one end portion;

a second optical fiber;

a second ferrule which has a cutout portion in at least a periphery of one end face thereof and holds the second optical fiber such that a front end of the second optical fiber becomes the same face as the one end face;

a second ferrule holder which houses a portion other than the one end face of the second ferrule and has a second flange on an outer circumference of the one end portion; and

an adhesive to be filled between the first flange and the second flange, into the cutout portion of the first ferrule, and into the cutout portion of the second ferrule.

According to a further embodiment of the present invention, a display apparatus comprises:

a modulation unit which performs spatial modulation of incident light in accordance with image information;

a semiconductor laser apparatus which comprises a semiconductor laser and a first optical fiber which transmits light emitted from the semiconductor laser;

a second optical fiber which transmits light emitted from the semiconductor laser apparatus to the modulation unit; and

a display unit which displays by projecting an optical output obtained from the modulation unit to a screen, wherein

the first optical fiber is held by a first ferrule, the first ferrule having a cutout portion in at least a periphery of one end face thereof, such that a front end of the first optical fiber becomes the same face as the one end face,

the second optical fiber is held by a second ferrule, the second ferrule having a cutout portion in at least a periphery of one end face thereof, such that a front end of the second optical fiber becomes the same face as the one end face, and

the one end face of the first ferrule and the one end face of the second ferrule are connected together by an adhesive.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a liquid-crystal projection TV (television) receiver according to a first embodiment of the present invention;

FIG. 2 is a view showing a configuration of a semiconductor laser apparatus shown in FIG. 1;

FIG. 3 is a view showing a detailed configuration of a major portion of the semiconductor laser apparatus shown in FIG. 2;

FIGS. 4A and 4B are views showing an example of the optical-fiber connector shown in FIG. 2;

FIG. 5 is a view showing another example of the optical-fiber connector shown in FIG. 2;

FIG. 6 is a view showing a further example of the optical-fiber connector shown in FIG. 2;

FIG. 7 is a view showing still another example of the optical-fiber connector shown in FIG. 2;

FIG. 8 is a view showing a still further example of the optical-fiber connector shown in FIG. 2;

FIG. 9 is a view showing still another example of the optical-fiber connector shown in FIG. 2; and

FIG. 10 is a view showing a liquid-crystal projection TV receiver according to a second embodiment of the present invention.

### DETAILED DESCRIPTION OF THE INVENTION

Embodiments of an optical-fiber connector and a display apparatus using optical fibers to be connected by the connector according to an embodiment of the present invention will now be described with reference to the accompanying drawings.

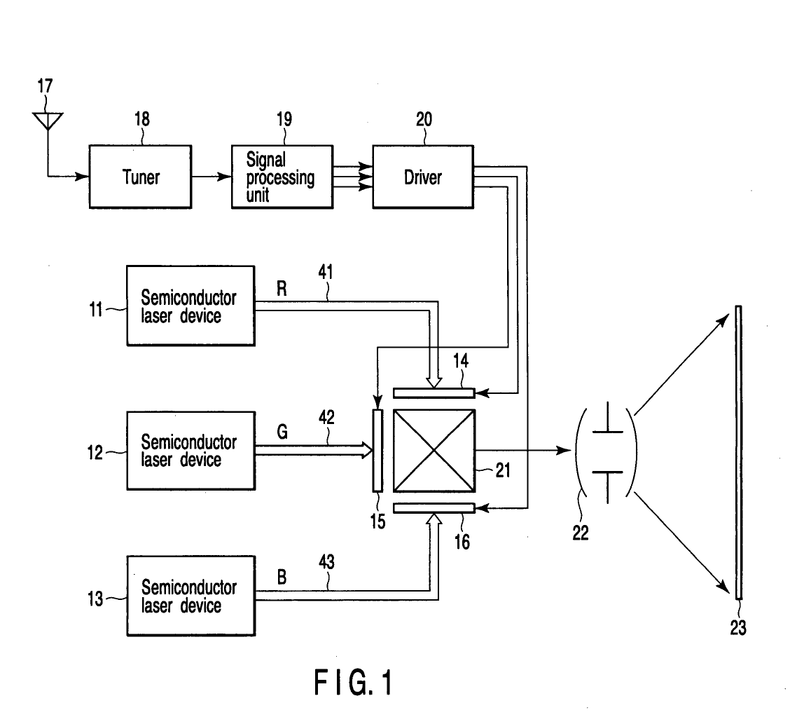

FIG. 1 shows a liquid-crystal projection TV (television) receiver by way of an example of the liquid crystal display apparatus.

By way of light sources of three colors, i.e., red (R), green (G), and blue (B) colors, semiconductor laser apparatuses 11, 12, and 13 are provided. Three beams of R, G, and B color laser light emitted from the semiconductor laser apparatuses 11, 12, and 13, respectively, are incident on liquid crystal panels 14, 15, and 16 provided corresponding to the individual beams of R, G, and B light via guiding optical fibers 41, 42, and 43. Each of the liquid crystal panels 14, 15, and 16 constitutes a spatial modulator.

On the other hand, a television broadcast signal received by an antenna 17 is tuned (channel-selected) by a tuner 18 and demodulated by a signal processing unit 19 into individual R, G, and B color video signals. The video signals are input to the individual liquid crystal panels 14, 15 and 16 via a driver 20. Thereby, the beams of R, G, and B laser light having been incident on the individual liquid crystal panels 14, 15 and 16 undergo spatial modulation according to the video signals, and are synthesized through a synthesizer such as a dichroic prism 21 or the like.

The synthesized light is zoomed and projected to a screen 23 through a projection lens 22, and television broadcast imagery is thereby displayed.

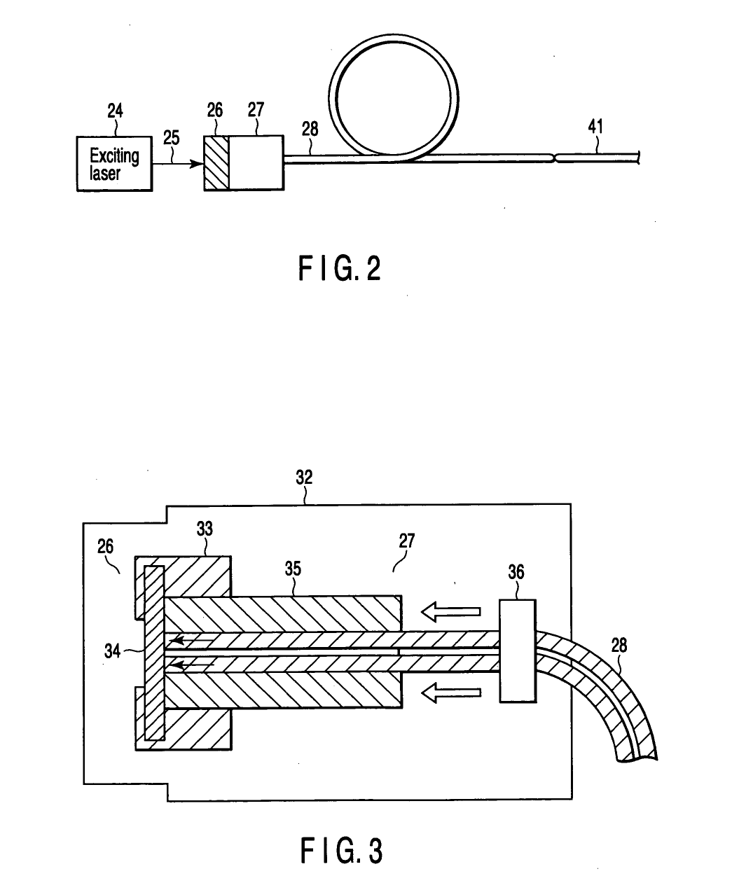

FIG. 2 is a view showing the detail of the semiconductor laser apparatus 11 shown in FIG. 1. The other semiconductor laser apparatuses 12 and 13 each have the same configuration as the semiconductor laser apparatus 11 except that the color of the laser light to be emitted is different, so that descriptions thereof will be omitted herefrom. The semiconductor laser apparatus shown in FIG. 2 is an up-conversion type semiconductor laser apparatus. More specifically, excitation light 25 emitted from an exciting laser 24 is incident on a mirror 26 which transmits light incident from one direction but reflects light having a specific wavelength and incident from the other direction. The mirror 26 allows the excitation light 25 to completely transmit.

The excitation light 25 having transmitted through the mirror 26 is input to the inside of an optical fiber 28 of which one end portion is held by a fiber holder 27. The optical fiber 28 comprises a core and a clad, in which the inside of the core is doped with rare earth elements as laser activation substances. The excitation light 25 input to the inside of the optical fiber 28 is absorbed by the rare earths, thereby light having a specific wavelength is emitted.

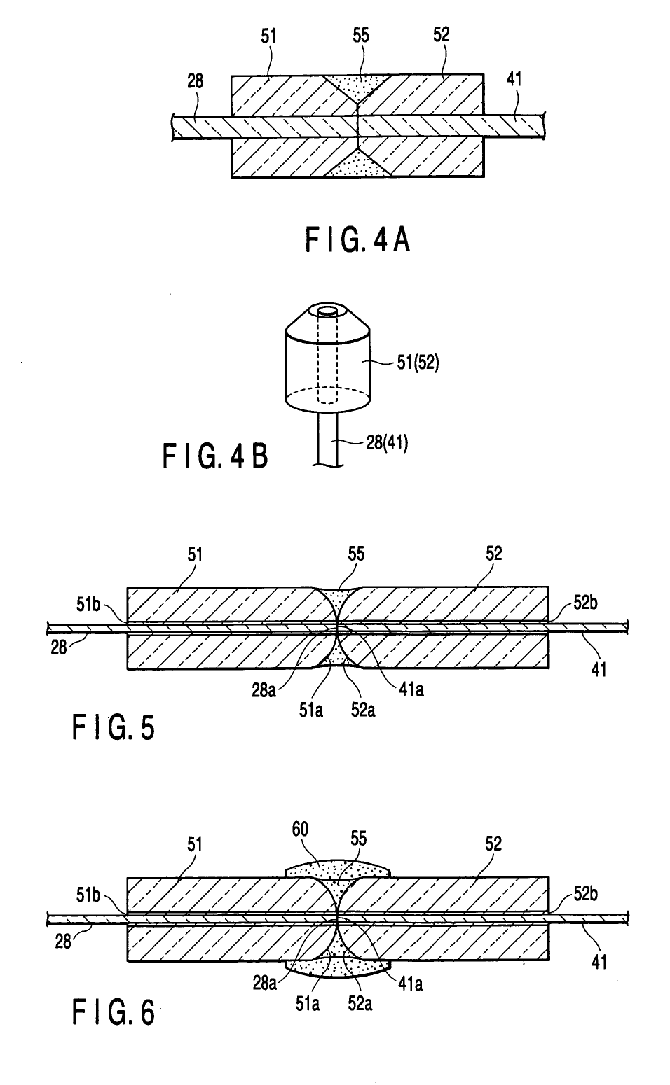

The other end portion of the optical fiber 28 is connected to the guiding optical fiber 41 by the optical-fiber connector of the present invention (not shown in FIG. 2 but shown in FIGS. 4A, 4B to 9). Although not shown, a mirror is provided also to the other end portion of the optical fiber 28. However, the mirror may not be provided to the other end portion of the optical fiber 28, but may instead be provided in an end portion of the guiding optical fiber 41. Thereby, with the optical fiber 28, light of a specific wavelength (red wavelength, for example) is resonated and output as laser light to the liquid crystal panel 14.

FIG. 3 is a view showing a detailed configuration of the mirror 26 and the fiber holder 27. The mirror 26 comprises a mirror holder 33 supported on a base cradle 32, and a mirror 34 held on the mirror holder 33. The mirror 34 is formed by vapor depositing a multilayer film over planar glass, in which a vapor deposition surface is disposed to face the side of the optical fiber 28.

The fiber holder 27 comprises a cylindrical ferrule 35 into which the optical fiber 28 is movably inserted, and a fastening device 36 for supporting the optical fiber 28 extending from the cylindrical ferrule 35 on the base cradle 32.

The ferrule 35 is fitted to the vapor deposition surface of the mirror 34 by being inserted into the mirror holder 33 perpendicularly to the mirror 34. In this case, preferably, no gap is present between the mirror holder 33 and the ferrule 35. Thereby, when the end face of the optical fiber 28 is brought into contact with the mirror 34, the optical fiber 28 can be pushed to abut the mirror 34 perpendicularly thereto. In addition, the optical fiber 28 is precut out by a fiber cutter or the like such that the end face thereof is planarized.

The optical fiber 28 is inserted into the ferrule 35. When the optical fiber 28 is in contact with the mirror 34, the optical fiber 28 is further pushed into the ferrule 35 to an extent that the optical fiber 28 is not broken. Thereby, a repulsive force returning to the original state is imparted to the optical fiber 28, and the optical fiber 28 with the repulsive force being remained is fixed with the fastening device 36 to the base cradle 32.

Therefore, with the repulsive force returning to the original state, the end face of the optical fiber 28 is all time press-fitted to the mirror 34. Accordingly, in such a simple configuration, the optical fiber 28 and the mirror 34 are efficiently optically connected together, thereby enabling optical transmission loss to be reduced.

Transmission loss can further be reduced by flowing matching oil or the like between the end face of the optical fiber 28 and the mirror 34.

The end face of the optical fiber 28 can be bonded with the mirror 34 by using, for example, an optical adhesive. Generally, when they are bonded, positional offsets, gaps, and the like are caused by an adhesive. However, since the optical fiber 28 is brought into press contact with the mirror 34, such problems can be avoided. More specifically, the optical fiber 28 and the mirror 34 are in secure contact with each other, so that interconnection loss can be reduced, and a stable laser output can be obtained.

FIGS. 4A and 4B are views showing an embodiment of the optical-fiber connector for connecting the up-conversion optical fiber 28 and the guiding optical fiber 41, which are shown in FIG. 2. Although not shown, a mirror is formed by vapor-depositing a multilayer film on at least one of the end faces of the optical fibers 28 and 41. As shown in FIG. 4A, front ends of the optical fibers 28 and 41 are respectively inserted into small bores of ferrules 51 and 52 and fixed with an adhesive. Unlike the conventional example, the front ends of the optical fibers 28 and 41 need not be extended from the ferrules 51 and 52, and are formed to have the same face. However, the ferrules 51 and 52 each have a cutout portion in a periphery of the end face thereof in a truncated cone shape, as shown in FIG. 4B. The cutout portions form a gap that allows the adhesive to be filled after the end faces of the ferrules 51 and 52 are press-fitted. Therefore, even in the case where the front ends of the optical fibers 28 and 41 are not extended from the end faces of ferrules 51 and 52, the end faces of the ferrules 51 and 52 (end faces of the optical fibers 28 and 41) can be bonded together. Since the front ends of the optical fibers 28 and 41 have the same face as the end faces of the ferrules 51 and 52, even when the end faces of the ferrules 51 and 52 are press-fitted with a great force, no fear of damaging the fibers takes place, and the connector enabling accurate axial alignment can be implemented.

Thus, in the example shown in FIGS. 4A and 4B, the technique is used to form the cutout portion in the truncated cone shape around the end face of each of the ferrules 51 and 52. However, the technique is not limited thereto, and a portion of the optical fiber other than the front end may be cut out by PC (physical contact) abrasion of the end face.

FIG. 5 shows an embodiment of the connector in the above case. In description hereinbelow, the same reference numerals are used to designate-the same portions as those in the above description, and detailed descriptions thereof will be omitted herefrom.

Front end portions of the optical fibers 28 and 41 are respectively inserted into small bores 51b and 52b of the ferrules 51 and 52 and fixed by an adhesive (not shown). Abutting end faces 51a and 52a of the ferrules 51 and 52 undergo PC (physical contact) abrasion. An end face 28a of the optical fiber 28 and the end face 51a of the ferrule 51, and an end face 41a of the optical fiber 41 and the end face 52a of the ferrule 52 form the same faces.

The optical fibers 28 and 41 are connected together in the following manner. The end face 51a of the ferrule 51 and the end face 52a of the ferrule 52 are placed opposite each other, and the end face 28a of the optical fiber 28 and the end face 41a of the optical fiber 41 are axially aligned and press-fitted together. In this state, an adhesive 55 is filled into a gap formed by the PC-abraded end face 51a of the ferrule 51 and the PC-abraded end face 52a of the ferrule 52. As described above, the end face 28a of the optical fiber 28 and the end face 51a of the ferrule 51, and the end face 41a of the optical fiber 41 and the end face 52a of the ferrule 52 form the same faces. Therefore, when the end face 28a of the optical fiber 28 and the end face 41a of the optical fiber 41 are axially aligned, the individual end faces of the optical fibers can be strongly press-fitted together without being damaged by press-fitting the end faces of the ferrules.

The end face 28a of the optical fiber 28 and the end face 41a of the optical fiber 41 are thus press-fitted together. As such, the adhesive 55 for fixing the abutting end faces fixes portions other than the optical fiber portions of the abutting end faces; that is, the adhesive 55 fixes the end face 51a of the ferrule 51 and the end face 52a of the ferrule 52 together. For the adhesive 55, there are usable adhesives of a thermosetting type and a photo-curing type. Taking into consideration a case where, if a slight gap is formed between the abutting portions of the end face 28a of the optical fiber 28 and the end face 41a of the optical fiber 41 because of, for example, a shaping error after the PC abrasion, the adhesive 55 may flow in the gap, the refractive index of the adhesive 55 is preferably an average value of the refractive index of the optical fiber 28 and the refractive index of the optical fiber 41. Usable materials for the ferrules 51 and 52 for holding the optical fibers 28 and 41 include, for example, zirconia and glass. When an adhesive of a photo-curable type is used for the adhesive 55, glass easily allowing light beams to transmit is preferable for the ferrules 51 and 52.

Also with the structure shown in FIG. 5, similar effects as that shown in FIGS. 4A and 4B can be obtained. In addition, in the structure shown in FIG. 5, since the PC-abraded end faces 51a and 52a provide the larger gap into which the adhesive is filled, the adhesion effect is greater.

In each of the two examples described above, although the adhesive is filled only into the cutout portion of the abutting end faces of the ferrules, other examples in which the adhesive is filled in other portions as well will be described hereinbelow.

In an example shown in FIG. 6, another adhesive 60 reinforces peripheral portions of the adhesive 55 and ferrules 51 and 52 in the structure shown in FIGS. 4A and 4B or FIG. 5 (in FIG. 6, a modified example of the structure shown in FIG. 5 is shown, but it can be adapted as well to the structure shown in FIGS. 4A and 4B). Similar to the adhesive 55, an adhesive of the thermosetting type, the photo-curable type, or the like may be used for the reinforcing adhesive 60; however, the same one as the adhesive 55 may be used.

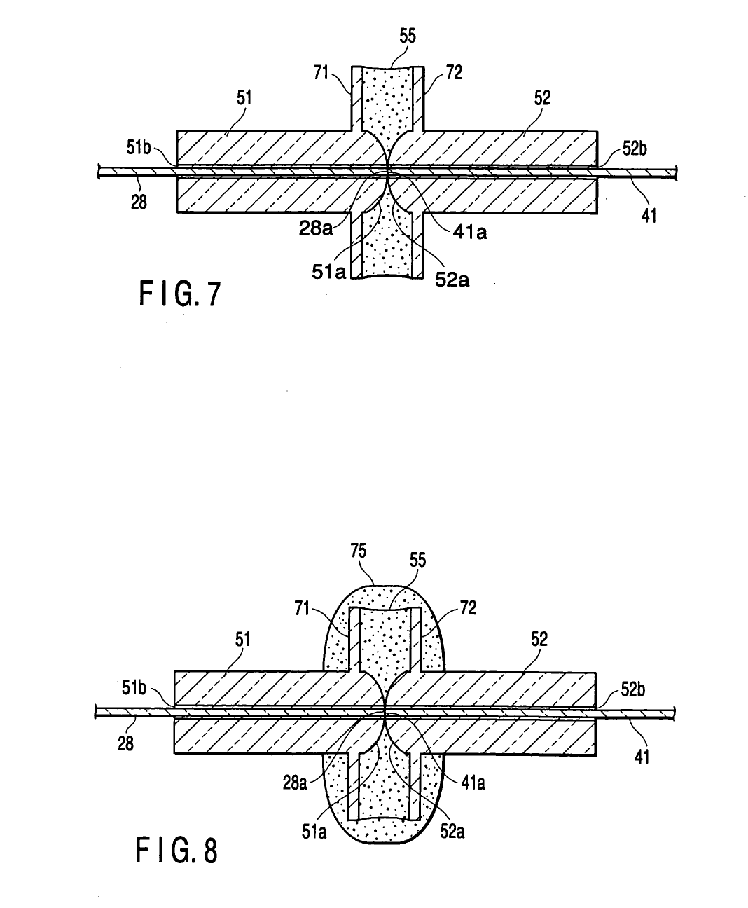

In an embodiment shown in FIG. 7, flanges 71 and 72 for securing adhesive-filling regions are provided on outer circumferences near the abutting end faces of the ferrules 51 and 52 (in the present example, a modified example of the structure shown in FIG. 5 is shown, but it can be adapted as well to the structure shown in FIGS. 4A and 4B). The adhesive 55 is filled for fixing in a region formed with the opposing end face 51a of the ferrule 51 and end face 52a of the ferrule 52 and a region formed with the flanges 71 and 72. The area of adhesion is increased by the region formed with the flanges 71 and 72, so that the structure has the effect of increasing the connection strength in comparison to the case shown in FIGS. 4A and 4B or FIG. 5 where the flanges are not provided.

In an example shown in FIG. 8, the modification shown in FIG. 6 is added to the connector shown in FIG. 7. More specifically, an adhesive 75 fixes an entire connection section including the two flanges 71 and 72 to further secure the corresponding connection strength.

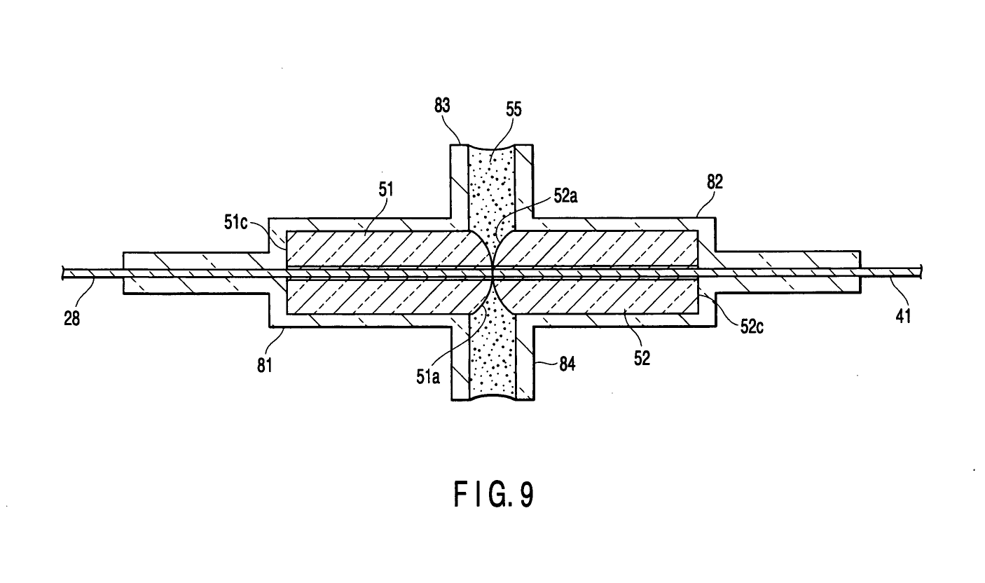

The flanges 71 and 72 provided around the outer circumferences of the ferrules 51 and 52 shown in FIGS. 7 and 8 may each be formed either as an integral unit or an independent unit. To form the flange as an independent unit, there are a technique of press-fitting the ferrules 51 and 52 into an annular flange and a technique of fixing them with an adhesive, for example. Alternatively, as shown in FIG. 9, end faces 51c and 52c opposing the abutting end faces 51a and 52a of the ferrules 51 and 52 are press-fitted into a metal or resin holders 81 and 82, and flanges 83 and 84 are formed close to the side of the abutting end faces 51a and 52a, whereby the flanges 83 and 84 are used to secure a filling area of the adhesive 55.

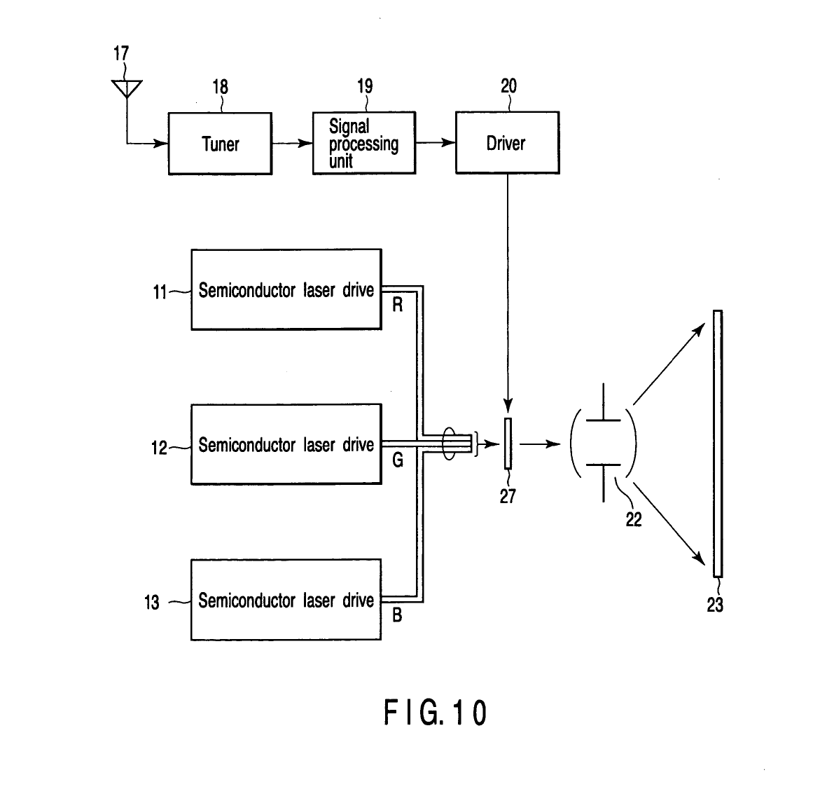

FIG. 10 shows another example of a liquid-crystal projection TV receiver. This example generates white light by macroscopically synthesizing beams of R, G, and B light obtained from individual semiconductor laser apparatuses 11, 12, and 13 into one. The white light is input to a liquid crystal panel 27 with color filters, is subjected to a spatial modulation according to a video signal from the driver 20, and is thereafter zoomed and projected the screen 23 via the projection lens 22. Of course, any one of the semiconductor laser apparatuses shown in FIGS. 3 to 9 may be used for the semiconductor laser apparatus 11, 12, or 13.

As described above, according to the embodiments of the present invention, there can be provided an optical-fiber connector that can be formed such that, when two optical fibers held in ferrules are connected, the optical fibers are less damaged, and a state where axial alignment is performed can be maintained to be secure. In addition, a display apparatus using the connector can be provided.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

1. An optical-fiber connector comprising:
a first optical fiber;
a first ferrule which has a cutout portion in at S least a periphery of one end face thereof and holds the first optical fiber such that a front end of the first optical fiber becomes the same face as the one end face;
a second optical fiber;
a second ferrule which has a cutout portion in at least a periphery of one end face thereof and holds the second optical fiber such that a front end of the second optical fiber becomes the same face as the one end face; and
an adhesive which connects the one end face of the first ferrule with the one end face of the second ferrule.

2. The optical-fiber connector according to claim 1, wherein the adhesive is filled into the cutout portion of the one end face of the first ferrule and into the cutout portion of the one end face of the second ferrule.

3. The optical-fiber connector according to claim 1, wherein the adhesive comprises:
a first adhesive to be filled into the cutout portion of the one end face of the first ferrule and into the cutout portion of the one end portion of the second ferrule; and
a second adhesive to be applied on an outer circumference of the first adhesive, an outer circumference of the first ferrule, and an outer circumference of the second ferrule.

4. The optical-fiber connector according to claim 1, wherein
a first flange formed on an outer circumference of the one end portion of the first ferrule,
a second flange formed on an outer circumference of the one end portion of the second ferrule, and
the adhesive is filled between the first flange and the second flange, into the cutout portion of the one end face of the first ferrule, and into the cutout portion of the one end face of the second ferrule.

5. The optical-fiber connector according to claim 1, wherein
a first flange formed on an outer circumference of the one end portion of the first ferrule,
a second flange formed on an outer circumference of the one end portion of the second ferrule, and
the adhesive comprises:
a first adhesive to be filled between the first flange and the second flange, into the cutout portion of the one end face of the first ferrule, and into the cutout portion of the one end face of the second ferrule; and
a second adhesive to be applied on an outer circumference of the first adhesive, an outer circumference of the first ferrule, and an outer circumference of the second ferrule.

6. The optical-fiber connector according to claim 1, wherein the one end face of the first optical fiber and the one end face of the second optical fiber each have a truncated cone shape.

7. The optical-fiber connector according to claim 1, wherein the one end face of the first optical fiber and the one end face of the second optical fiber are each a curved face.

8. The optical-fiber connector according to claim 7, wherein the one end face of the first optical fiber and the one end face of the second optical fiber are each a curved face formed by PC (physical contact) abrasion.

9. An optical-fiber connector according to claim 1, wherein materials of the first optical fiber and the second optical fiber are different from each other.

10. An optical-fiber connector comprising:
a first optical fiber;
a first ferrule which has a cutout portion in at least a periphery of one end face thereof and holds the first optical fiber such that a front end of the first optical fiber becomes the same face as the one end face;
a first ferrule holder which houses a portion other than the one end face of the first ferrule and has a first flange on an outer circumference of the one end portion;
a second optical fiber;
a second ferrule which has a cutout portion in at least a periphery of one end face thereof and holds the second optical fiber such that a front end of the second optical fiber becomes the same face as the one end face;
a second ferrule holder which houses a portion other than the one end face of the second ferrule and has a second flange on an outer circumference of the one end portion; and
an adhesive to be filled between the first flange and the second flange, into the cutout portion of the first ferrule, and into the cutout portion of the second ferrule.

11. The optical-fiber connector according to claim 10, wherein the one end face of the first optical fiber and the one end face of the second optical fiber each have a truncated cone shape.

12. The optical-fiber connector according to claim 10, wherein the one end face of the first optical fiber and the one end face of the second optical fiber are each a curved face.

13. The optical-fiber connector according to claim 12, wherein the one end face of the first optical fiber and the one end face of the second optical fiber are each a curved face formed by PC (physical contact) abrasion.

14. An optical-fiber connector according to claim 10, wherein materials of the first optical fiber and the second optical fiber are different from each other.

15. A display apparatus comprising:
a modulation unit which performs spatial modulation of incident light in accordance with image information;
a semiconductor laser apparatus which comprises a semiconductor laser and a first optical fiber which transmits light emitted from the semiconductor laser;
a second optical fiber which transmits light emitted from the semiconductor laser apparatus to the modulation unit; and
a display unit which displays by projecting an optical output obtained from the modulation unit to a screen, wherein
the first optical fiber is held by a first ferrule, the first ferrule having a cutout portion in at least a periphery of one end face thereof, such that a front end of the first optical fiber becomes the same face as the one end face,
the second optical fiber is held by a second ferrule, the second ferrule having a cutout portion in at least a periphery of one end face thereof, such that a front end of the second optical fiber becomes the same face as the one end face, and
the one end face of the first ferrule and the one end face of the second ferrule are connected together by an adhesive.

16. The display apparatus according to claim 15, wherein
the semiconductor laser apparatus and the modulation unit comprise three elements corresponding to red light, green light, and blue light, and
the display unit synthesizes optical outputs from the three elements of the modulation unit corresponding to the red light, the green light, and the blue light into one optical output to be projected to the screen.

17. The display apparatus according to claim 15, wherein
the semiconductor laser apparatus comprises three elements corresponding to red light, green light, and blue light,
the second optical fiber comprises three elements corresponding to red light, green light, and blue light, and
the modulation unit performs spatial modulation of a light obtained by synthesizing three lights output from the three elements of the second optical fiber.
